(19) United States
(12) Patent Application Publication
(10) Pub. No.: US 2013/0149613 A1
(43) Pub. Date: Jun. 13, 2013

(54) Ceramic Separator and Storage Device

(71) Applicant: Murata Manufacturing.Co., Ltd., Nagaokakyo-Shi (JP)

(72) Inventors: Norihiro Yoshikawa, Nagaokakyo-Shi (JP); Ichiro Nakamura, Nagaokakyo-Shi (JP)

(73) Assignee: Murata Manufacturing Co., Ltd., Nagaokakyo-shi (JP)

(21) Appl. No.: 13/734,009

(22) Filed: Jan. 4, 2013

Related U.S. Application Data
(63) Continuation of application No. PCT/JP2011/064750, filed on Jun. 28, 2011.

(30) Foreign Application Priority Data
Jul. 5, 2010 (JP) 2010-153150

(51) Int. Cl. H01M 2/16; H01G 9/00; H01M 4/64

(52) U.S. Cl. CPC H01M 2/1646; H01M 4/64; H01G 9/155
USPC 429/233; 429/247; 361/502

(57) ABSTRACT

A ceramic separator that includes an inorganic filler and an organic constituent. The inorganic filler is in the range of 55 to 80% in terms of a pigment volume concentration, and the inorganic filler has an average particle diameter of 1 μm to 5 μm, and a grain size distribution with a slope of 1.2 or more based on an approximation by a Rosin-Rammler distribution.

### CROSS REFERENCE TO RELATED APPLICATIONS

The present application is a continuation of International application No. PCT/JP2011/064750, filed Jun. 28, 2011, which claims priority to Japanese Patent Application No. 2010-153150, filed Jul. 5, 2010, the entire contents of each of which are incorporated herein by reference.

### FIELD OF THE INVENTION

The present invention relates to a ceramic separator and a storage device.

### BACKGROUND OF THE INVENTION

Separators for insulating a positive electrode and a negative electrode from each other while holding an electrolytic solution are used for storage devices such as lithium ion secondary batteries. Separators composed of a polyethylene microporous membrane disclosed in, for example, Non-Patent Document 1 is mainly used as separators for lithium ion secondary batteries.

Recently, separators have been also disclosed which are formed from a mixture of a resin with an inorganic substance.

For example, Patent Document 1 discloses a microporous separator mainly containing a mixture of an olefinic plastic with hydrous silica, and Patent Document 2 discloses a separator which has a structure with a resin layer provided on at least one principal surface of a base material layer, and has the resin layer including an inorganic substance in the range of 1 nm to 10 μm in particle size.

In addition, Patent Document 3 discloses a separator containing inorganic particulates, in which the number of particulates of 0.3 μm or less in particle diameter and the number of particulates of 1 μm or more in particle diameter are each adjusted to 10% or more of the total number of inorganic particulates. Furthermore, Non-Patent Document 2 discloses a ceramic-particulate composite separator in which ceramic particulates (0.01 μm or 0.3 μm in particle diameter) and a binder resin are combined at a predetermined pigment volume concentration (PVC).

These separators of the composite materials composed of an inorganic powder and an organic constituent are intended to suppress the shrinkage caused in polyethylene microporous membranes.
Patent Document 1: JP 60-249266 A
Patent Document 2: JP 2007-188777 A
Patent Document 3: JP 2008-210541 A
Non-Patent Document 1: Polymer Preprints, Japan Vol. 58, No. 1, p. 34-36 (2009), Title: Development of Polyethylene Microporous Membrane Contributing to Higher Performance of Lithium Ion Secondary Battery (Asahi Kasei Corporation/National Institute of Advanced Industrial Science and Technology)
Non-Patent Document 2: Proceedings of Battery Symposium, Vol. 45, p. 542-543 (2004), Title: Evaluation of Basic Characteristics of Lithium Secondary Battery using PTC Function Electrode/Ceramic Particulate Composite Separator (Mitsubishi Electric Corporation)

### SUMMARY OF THE INVENTION

However, the separator composed of the polyethylene microporous membrane as disclosed in Non-Patent Document 1 uses a monoaxially-oriented or biaxially-oriented film in order to improve the strength, thus leading to the problem of strain accumulated by the stretching operation, and then shrinkage caused significantly by exposure to high temperatures.

In recent years, lithium ion secondary batteries are intended to be increased in energy density, and separators are getting to be exposed to higher temperature. Thus, the film shrinkage caused by residual stress is a more significant problem.

In addition, the separators of the composite materials composed of the inorganic powder and the organic constituent, which are disclosed in Patent Document 1, etc., are prepared in such a way that the gaps filled with the inorganic powder are bound with the organic constituent, and require the adjustment of the porosity and air permeability for the separators, that is, the adjustment of the filling property of the inorganic powder in order to ensure the separator function of allowing the permeation of lithium ions. However, none of conventional separators can ensure the air permeability required for the separators, or has sufficiently reduced shrinkage in the case of exposure to high temperatures.

For example, the inorganic powder has an increased broad grain size distribution width in the case of the separator disclosed in Patent Document 3. However, this increase leads to dense filling with the inorganic powder, thereby resulting in a failure to achieve the air permeability required for the separator, for example, a failure to ensure the permeation of lithium ions.

Therefore, an object of the present invention is to provide a ceramic separator which can ensure the air permeability required for the separator, and has reduced shrinkage in the case of exposure to high temperatures, and a storage device including the ceramic separator.

In order to solve the problems described above, a ceramic separator according to the present invention including an inorganic filler and an organic constituent is characterized in that:

the ceramic separator includes the inorganic filler in the range of 55 to 80% in terms of pigment volume concentration; and the inorganic filler has an average particle diameter of 1 μm to 5 μm, and a grain size distribution with a slope of 1.2 or more in the case of an approximation by a Rosin-Rammler distribution.

The ceramic separator configured as described above according to the present invention includes the inorganic filler in the range of 55 to 80% in terms of pigment volume concentration; and the inorganic filler has an average particle diameter of 1 μm to 5 μm, and a grain size distribution with a slope of 1.2 or more in the case of an approximation by a Rosin-Rammler distribution. Thus, the air permeability preferred as the separator can be achieved without decreasing the strength.

The ceramic separator according to the present invention preferably contains the inorganic filler in the range of 60 to 80% in terms of pigment volume concentration, and the inorganic filler preferably has an average particle diameter of 3 μm to 5 μm.

The ceramic separator according to the present invention more preferably contains the inorganic filler in the range of 60 to 75% in terms of pigment volume concentration.

In addition, a storage device according to the present invention is characterized by including the ceramic separator between a positive electrode and a negative electrode.

As described above, the ceramic separator according to the present invention can provide a ceramic separator which can ensure the air permeability required for the separator, and has reduced shrinkage in the case of exposure to high temperatures, and a storage device including the ceramic separator.

### BRIEF EXPLANATION OF THE DRAWINGS

FIG. 1 is a schematic plan view of a lithium ion secondary battery 100 according to Embodiment 2 of the present invention.

FIG. 2 is a partial cross-sectional view illustrating an enlarged cross section viewed from a direction along line II-II of FIG. 1.

FIG. 3 is a partial cross-sectional view schematically illustrating an enlarged structure of an battery element 10 in a lithium ion secondary battery according to Embodiment 2 of the present invention.

FIG. 4 is a cross-sectional view schematically illustrating the structure of an electrical double layer capacitor 200 according to Embodiment 3 of the present invention.

FIG. 5 is a partial cross-sectional view schematically illustrating an enlarged structure of a capacitor element 20 in an electrical double layer capacitor according to Embodiment 3 of the present invention.

FIG. 6 is a graph showing the relationship between the pore diameter and Log differential pore volume distribution (dV/d(logD)) of sample 1 according to Example 1 of the present invention.

FIG. 7 is a graph showing the relationship between the pore diameter and Log differential pore volume distribution (dV/d(logD)) of sample 2 according to Example 1.

FIG. 8 is a graph showing the relationship between the pore diameter and Log differential pore volume distribution (dV/d(logD)) of sample 3 according to Example 1.

FIG. 9 is a graph showing the relationship between the pore diameter and Log differential pore volume distribution (dV/d(logD)) of a comparative example.

### DESCRIPTION OF THE PREFERRED EMBODIMENTS OF THE INVENTION

A ceramic separator according to Embodiment 1 of the present invention will be described below.

### Embodiment 1

The ceramic separator according to Embodiment 1 is composed of, for example, a composite material where an inorganic filler which is chemically and electrochemically stable in a storage device such as a lithium ion secondary battery is bound with an organic constituent which is chemically and electrochemically stable in a lithium ion secondary battery. In addition, the organic constituent preferably has a high heatproof temperature, and for example, a resin is selected which has a heatproof temperature of 150° C. or higher.

Examples of this inorganic filler which is chemically and electrochemically stable in a storage device include, for example, oxides such as silica, alumina, titania, magnesia, and barium titanate, and nitrides such as a silicon nitride and an aluminum nitride.

In addition, the average particle diameter of the inorganic filler is set to be 1 μm or more and 5 μm or less.

More specifically, as demonstrated in examples to be described, in the case of the ceramic separator of the composite material composed of the inorganic filler and the organic constituent, the porosity and air permeability are determined by the filling property of the inorganic filler, and the sizes of pores formed between the inorganic fillers in the ceramic separator is correlated with the average particle diameter of the inorganic filler. Specifically, there is a tendency to increase the sizes of the pores with the increase in average particle diameter, and when the average particle diameter is smaller than 1 μm, the sizes of the pores in the ceramic separator will be reduced to make it difficult to achieve preferable air permeability as a ceramic separator for a storage device.

On the other hand, the average particle diameter of 5 μm or less preferably makes it possible to prepare, for example, a separator on the order of 10 μm to 30 μm in film thickness for use in a storage device, without decreasing the strength of the ceramic separator. Thus, when the average particle diameter is excessively large with respect to the film thickness, the strength of the ceramic separator will be decreased to generate concern about a problem with reliability. Specifically, when the average particle diameter is larger than 5 μm, the ratio of the average particle diameter of the inorganic filler to the thickness will be increased to make the strength of the film likely to be decreased or make the reliability as a separator to be decreased, in the ceramic separator on the order of 10 μm to 30 μm in film thickness.

In view of the foregoing, the average particle diameter of the inorganic filler is set in the range of 1 to 5 μm in the case of the ceramic separator according to Embodiment 1.

Furthermore, in the case of the ceramic separator according to Embodiment 1, the average particle diameter of the inorganic filler is set so as to be 1 μm or more and 5 μm or less, and in addition, the particle size distribution of the inorganic filler is set so that the slope (abbreviated as an n value) is 1.2 or more in the case of the approximation by a Rosin-Rammler distribution. When the n value is less than 1.2, the particle size distribution width of the inorganic filler is increased to fill the ceramic separator densely with the inorganic filler. As a result, the porosity and the air permeability will be decreased to decrease the function of allowing the permeation of an electrolytic solution, which is required as a ceramic separator for a storage device. Therefore, the particle size distribution width reduced to the n value of 1.2 or more can suppress the excessively dense filling with the inorganic filler to achieve a high-porosity ceramic separator.

In this case, the n value is calculated by the following formula (1) on the basis of the particle size distribution of the inorganic filler.

R(Dp)=100×exp(−bDp″) (1)

In the formula (1), Dp is a particle size, R(Dp) is cumulative oversize weight %, b is a constant, and n is an n value.

It is to be noted that the average particle diameter and particle size distribution of the inorganic filler were measured by a laser-diffraction particle size distribution measurement method with Microtrack FRA from Nikkiso Co., Ltd. In addition, the n value was calculated by linear regression from the measured particle size distribution with the use of the formula (1) mentioned above.

Examples of the organic constituent for use in the ceramic separator include organic constituents containing phenoxy, epoxy, polyvinyl butyral, polyvinyl alcohol, urethane, acrylic, ethyl cellulose, methyl cellulose, carboxymethyl cellulose, or polyvinylidene fluoride.

Furthermore, in the case of the ceramic separator according to Embodiment 1, the pigment volume concentration (PVC: Pigment Volume Concentration) calculated by the following formula (2) is set in the range of 55 to 80%. If the pigment volume concentration is less than 55%, the volume ratio of the organic constituent to the inorganic filler will be increased to increase the amount of the organic constituent which fills the gaps between the inorganic fillers. As a result, the porosity of the ceramic separator will be decreased to make the aqueous electrolytic solution less likely to permeate the ceramic separator.

Alternatively, the pigment volume concentration greater than 80% will decrease the strength of the ceramic separator as the composite material and the amount of the organic constituent for maintaining elasticity, and the strength and flexibility of the ceramic separator will be thus decreased to make handling difficult in the manufacturing process.

Pigment Volume Concentration=(Volume of Inorganic Filler)/(Volume of Inorganic Filler+Volume of Organic Constituent)×100 (2)

where the volume of the inorganic filler is given by (Weight of Inorganic Filler)/(Density of Inorganic Filler), and the volume of the organic constituent is given by (Weight of Organic Constituent)/(Density of Organic Constituent).

This ceramic separator is prepared in such a way that slurry prepared from the inorganic filler, the organic constituent, and a solvent with the use of, for example, a ball mill is casted onto a base material such as a carrier film or a metal roll by a doctor blade method, dried, and then peeled from the base material.

The ceramic separator configured as described above according to Embodiment 1 can reduce the shrinkage at high temperatures while ensuring the high porosity and high permeability required as for a storage device, and makes it possible to ensure high safety in the storage device.

Storage devices according to embodiments of the present invention will be described below with reference to the drawings.

### Embodiment 2

A lithium ion secondary battery according to Embodiment 2 of the present invention is configured to include the ceramic separator according to Embodiment 1 of the present invention.

It is to be noted that an inorganic filler which is chemically and electrochemically stable in the lithium ion secondary battery is preferably selected in the case of the ceramic separator for use in the lithium ion secondary battery according to Embodiment 2, and an organic constituent is preferably selected which has a heatproof temperature of, for example, 150° C. or more.

The lithium ion secondary battery 100 according to Embodiment 2 will be described below in detail.

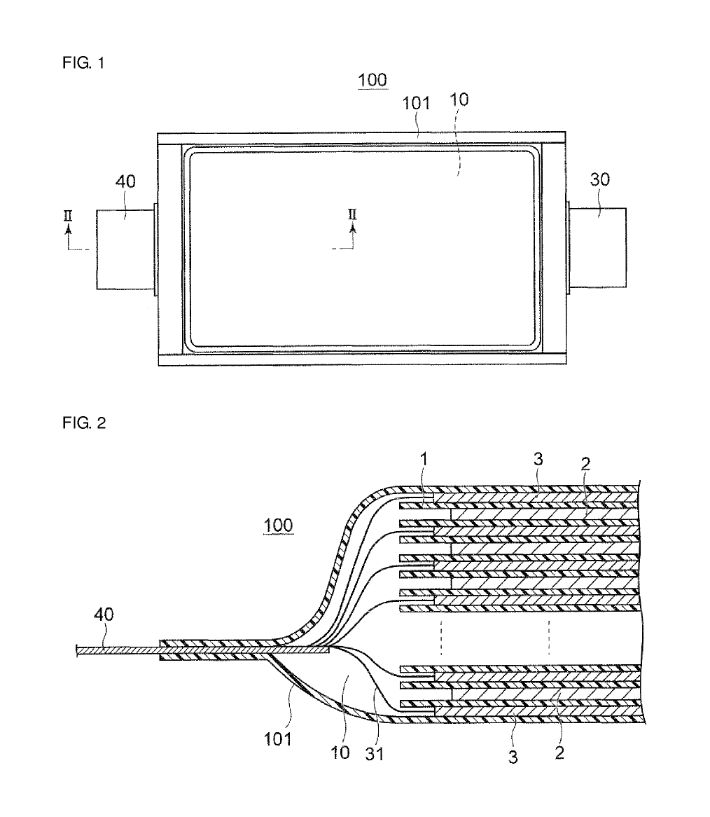

The lithium ion secondary battery 100 according to Embodiment 2 of the present invention is composed of: as shown in FIG. 1, a battery element 10; an exterior member 101 for housing and sealing the battery element 10; and a positive electrode terminal 30 and a negative electrode terminal 40 connected to the battery element 10 through a plurality of current collecting sections and extracted from the outer periphery of the exterior member 101 in directions opposite to each other.

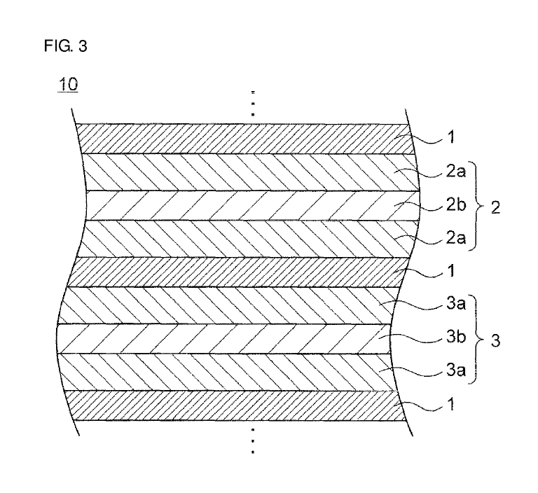

The battery element 10 includes: as shown in the enlarged view of FIGS. 2 and 3, a laminated body with a ceramic separator 1 provided between a positive electrode plate 2 and a negative electrode plate 3, for insulating the positive electrode plate 2 and the negative electrode plate 3 from each other; and a non-aqueous electrolytic solution, not shown. Although FIG. 3 shows therein only one positive electrode plate 2 and only one negative electrode plate 3, this laminated body is preferably a laminated structure which includes a plurality of positive electrode plates 2 and a plurality of negative electrode plates 3, and has ceramic separators 1 provided respectively between the positive electrode plates 2 and negative electrode plates 3 arranged alternately, thereby making it possible to constitute a lithium ion secondary battery which has a high storage capacity.

The lithium ion secondary battery 100 according to Embodiment 2 has the battery element 10 packed in the exterior member 101 composed of, for example, an aluminum laminate film. Furthermore, on the negative electrode side, as shown in FIG. 2, the negative electrode plates 3 are each connected to the negative electrode terminal 40 through the current collecting sections in the uncoated region. Although not shown, the positive electrode plates 11 are also connected to the positive electrode terminal 30 in the same manner.

<Positive Electrode Plate 2>

In this battery element 10 according to Embodiment 2, the positive electrode plate 2 is composed of a positive electrode current collector 2b and a positive electrode active material layer 2a provided on the surface of the positive electrode current collector 2b. When, for example, the laminated structure as shown in FIG. 3 is adopted for the battery element 10, the positive electrode active material layer 2a is provided on one surface of the positive electrode current collector 2b for the positive electrode plate 2 placed as the outermost layer of the laminated structure, whereas the positive electrode active material layer 2a is provided on both surfaces of the positive electrode current collector 2b for the positive electrode plate 2 placed inside.

In addition, the positive electrode active material layer 2a of the positive electrode plate 2 is formed in such a way that a positive electrode mix containing a positive electrode active material, a binder, and a conducting aid is applied onto one or both surfaces of the positive electrode current collector 2b, and dried.

Metal sulfides or oxides such as TiS₂, MoS₂, NbSe₂, and V₂O₅ can be used as the positive electrode active material constituting the positive electrode active material layers 2a in the lithium ion secondary battery. In addition, a lithium composite oxide mainly containing LiMₓO₂ (in the chemical formula, M represents one or more transition metals, and x which varies depending on the charge/discharge state of the battery, is typically 0.05 or more and 1.10 or less), etc. can be used as the positive electrode active material in the lithium ion secondary battery. Co, Ni, Mn, and the like are preferred as the transition metal M constituting the lithium composite oxide. Specific examples of this lithium composite oxide can include LiCoO₂, LiNiO₂, LiNi_{y}Co_{1-y}O₂ (in the chemical formula, 0<y<1), Li₁₊ₐ(NiₓCo_{y}Mn_{z})O_{2-b} (in the chemical formula, −0.1<a<0.2, x+y+z=1, −0.1<b<0.1), and LiMn₂O₄. These lithium composite oxides can generate high voltages, and serves as positive electrode active materials which are excellent in energy density. In order to prepare the positive electrode plates 2, more than one of these positive electrode active materials may be combined and used.

In addition, known binders which are used in positive electrode mixes for lithium ion batteries can be typically used as the binder contained in the positive electrode mix mentioned above, and known additives such as conducting aids can be added to the positive electrode mix mentioned above.

<Negative Electrode Plate 3>

In this battery element 10 according to Embodiment 2, the negative electrode plate 3 is composed of a negative electrode current collector 3b and a negative electrode active material layer 3a provided on the surface of the negative electrode current collector 3b. When, for example, the laminated structure as shown in FIG. 3 is adopted for the battery element 10, the negative electrode active material layer 3a is provided on one surface of the negative electrode current collector 3b for the negative electrode plate 3 placed as the outermost layer of the laminated structure, whereas the negative electrode active material layer 3a is provided on both surfaces of the negative electrode current collector 3b for the negative electrode plate 3 placed inside.

In addition, the negative electrode active material layer 3a of the negative electrode plate 3 is formed in such a way that a negative electrode mix containing a negative electrode active material, a binder, and a conducting aid is applied onto one or both surfaces of the negative electrode current collector 3b, and dried.

A material which can be doped or undoped with lithium is preferably used as the negative electrode active material constituting the lithium ion secondary battery. Carbon materials such as, for example, non-graphitizable carbonaceous materials and graphite materials can be used as the material which can be doped or undoped with lithium. Specifically, carbon materials can be used, such as pyrolytic carbon, coke, graphite, glassy carbon fibers, fired organic polymer compounds, carbon fibers, and activated carbon. The coke mentioned above includes pitch coke, needle coke, and petroleum coke. In addition, the fired organic polymer compounds refer to phenol resins, furan resins, etc., made carbonaceous by firing at appropriate temperatures. Besides the carbon materials mentioned above, polymers such as polyacetylene and polypyrrole and oxides such as SnO₂ and Li₄Ti₅O₁₂ (lithium titanate) can be also used as the material which can be doped or undoped with lithium.

In addition, known binders which are used in negative electrode mixes for lithium ion batteries can be typically used as the binder contained in the negative electrode mix mentioned above, and known additives such as conducting aids can be added to the negative electrode mix mentioned above.

<Non-Aqueous Electrolytic Solution>

The non-aqueous electrolytic solution is prepared by dissolving an electrolyte in a non-aqueous solvent. For example, LiPF₆ dissolved at a concentration of 1.0 mol/L in a non-aqueous solvent is used as the non-aqueous electrolytic solution. Besides LiPF₆, examples of the electrolyte include lithium salts such as LiBF₄, LiAsF₆, LiClO₄, LiCF₃SO₃, LiN(SO₂CF₃)₂, LiC(SO₂CF₃)₃, LiAlCl₄, and LiSiF₆. Among these lithium salts, it is desirable to use, in particular, LiPF₆ or LiBF₄ as the electrolyte in terms of oxidation stability. This electrolyte is preferably dissolved and used at a concentration of 0.1 mol/L to 3.0 mol/L, and more preferably dissolved and used at a concentration of 0.5 mol/L to 2.0 mol/L in a non-aqueous solvent. Cyclic carbonates such as propylene carbonate and ethylene carbonate; chain carbonates such as diethyl carbonate and dimethyl carbonate; carboxylic esters such as methyl propionate and methyl butyrate; ethers such as γ-butyrolactone, sulfolane, 2-methyltetrahydrofuran, and dimethoxyethane; etc. can be used as the non-aqueous solvent. These non-aqueous solvents may be used by themselves, or more than one of the solvents may be used in combination. Among these solvents, it is preferable to use, in particular, the carbonates as the non-aqueous solvent in terms of oxidation stability. For example, propylene carbonate, ethylene carbonate, and diethyl carbonate mixed in proportions of 5 to 20:20 to 30:60 to 70 in terms of volume ratio are used as the non-aqueous solvent.

It is to be noted that while the ceramic separator 1 is interposed between the positive electrode plate 2 and the negative electrode plate 3 in the example of the lithium ion secondary battery shown in FIG. 3, more than one ceramic separator 1 may be interposed therebetween. In the case of using more than one ceramic separator 1, ceramic separators 1 may be used which differ in, for example, the material, average particle diameter, n value of the inorganic filler.

The lithium ion secondary battery configured as described above according to Embodiment 2 uses the ceramic separator 1 which ensures the porosity and air permeability required for the lithium ion secondary battery, and reduces the strength and shrinkage during heating, thus making it possible to achieve a longer life and increase the reliability.

In addition, the ceramic separator of the composite material composed of the inorganic filler and the organic constituent according to Embodiment 1 can have a pore diameter distribution width reduced as compared with separators composed of polyethylene microporous membranes for storage devices. Therefore, as compared with a lithium ion secondary battery using a separator composed of a polyethylene microporous membrane, the lithium ion secondary battery according to Embodiment 2 can make the distribution of the non-aqueous electrolytic solution and the movement of lithium ions uniform in the separator, improve the reliability, and achieve a longer life.

### Embodiment 3

An electrical double layer capacitor according to Embodiment 3 of the present invention is configured to include the ceramic separator according to Embodiment 1.

It is to be noted that an inorganic filler and an organic constituent which are chemically and electrochemically stable in the electrical double layer capacitor are preferably selected for the ceramic separator of the electrical double layer capacitor according to Embodiment 3.

The electrical double layer capacitor according to Embodiment 3 will be described below in detail.

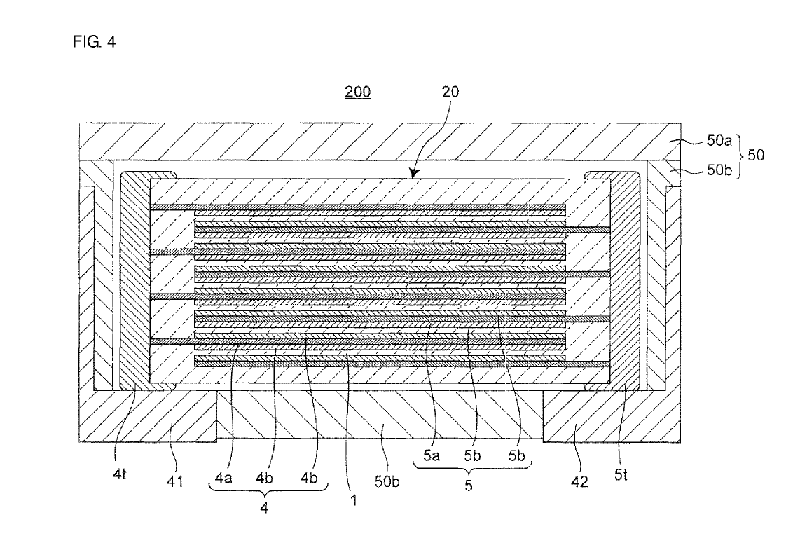

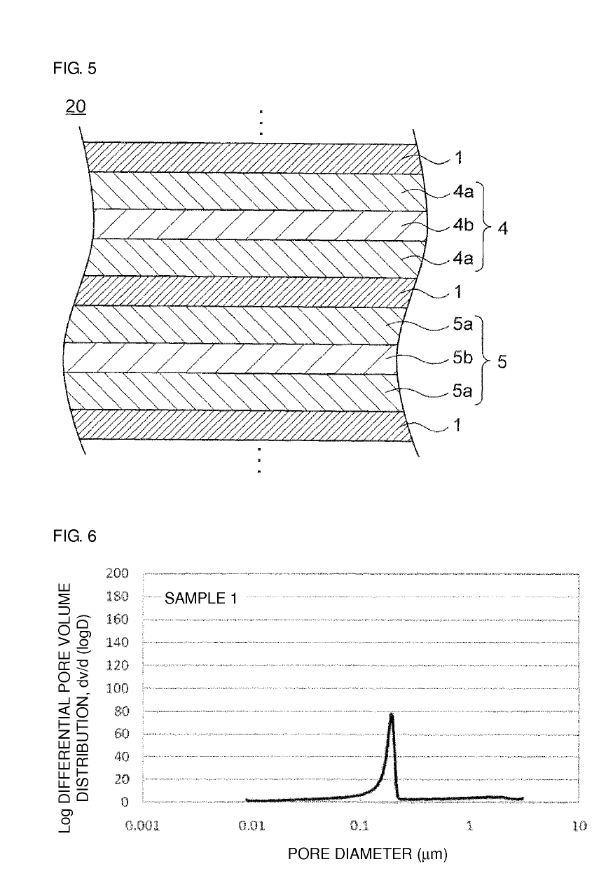

The electrical double layer capacitor according to Embodiment 3 of the present invention includes a capacitor element 20 and a package 50 as shown in FIG. 4. The capacitor element 20 has, as shown in FIGS. 4 and 5, a ceramic separator 1 between a positive electrode plate 4 and a negative electrode plate 5 provided to be opposed to each other, for insulating the positive electrode plate 4 and the negative electrode plate 5 from each other while holding an electrolytic solution, not shown. This capacitor element 20 according to Embodiment 3 is preferably a laminated structure which includes a plurality of positive electrode plates 4 and a plurality of negative electrode plates 5, and has ceramic separators 1 provided respectively between the positive electrode plates 4 and negative electrode plates 5 arranged alternately, thereby making it possible to constitute the electrical double layer capacitor 20 which has a high electrostatic capacitance. In addition, a positive electrode external terminal electrode 4t is formed on one end surface of the capacitor element 20 so as to be connected to positive electrode current collector layers 4a, whereas a negative electrode external terminal electrode 5t is formed on the other end surface thereof so as to be connected to negative electrode current collector layers 5a.

The capacitor element 20 configured as described above is, as shown in FIG. 4, provided in the package 50 with an electrolytic solution injected therein. This package 50 is composed of a base section 50b and a lid body 50a which are formed from, for example, a liquid crystal polymer as a heat-resistance resin, and the base section 50b is provided separately with a positive electrode package electrode 41 and a negative electrode package electrode 42.

In the base section 50b, the positive electrode external terminal electrode 4t of the laminated body 1 is connected to the positive electrode package electrode 41 of the base section 50b, whereas the negative electrode external terminal electrode 5t is connected to the negative electrode package electrode 42.

<Positive Electrode Plate 4>

In this capacitor element 20 according to Embodiment 3, the positive electrode plate 4 is composed of a positive electrode current collector 4b and a positive electrode active material layer 4a provided on the surface of the positive electrode current collector 4b. When, for example, the laminated structure as shown in FIG. 5 is adopted for the capacitor element 20, the positive electrode active material layer 4a is provided on only one surface of the positive electrode current collector 4b for the positive electrode plate 4 placed as the outermost layer of the laminated structure, whereas the positive electrode active material layer 2a is provided on both surfaces of the positive electrode current collector 4b for the positive electrode plate 4 placed inside.

In addition, the positive electrode active material layer 4a of the positive electrode plate 4 is formed in such a way that a positive electrode mix containing a positive electrode active material, a binder, and a conducting aid is applied onto one or both surfaces of the positive electrode current collector 4b, and dried.

The positive electrode active material layer 4a can be formed by applying a positive electrode mix containing a carbon material, for example, activated carbon onto the positive electrode current collector 4b composed of, for example, aluminum foil.

In addition, known binders which are used in positive electrode mixes for lithium ion batteries can be typically used as the binder contained in the positive electrode mix mentioned above, and known additives such as conducting aids can be added to the positive electrode mix mentioned above.

<Negative Electrode Plate 5>

In this battery element 20 according to Embodiment 3, the negative electrode plate 5 is composed of a negative electrode current collector 5b and a negative electrode active material layer 5a provided on the surface of the negative electrode current collector 5b. When, for example, the laminated structure as shown in FIG. 5 is adopted for the battery element 20, the negative electrode active material layer 5a is provided on one surface of the negative electrode current collector 5b for the negative electrode plate 5 placed as the outermost layer of the laminated structure, whereas the negative electrode active material layer 5a is provided on both surfaces of the negative electrode current collector 5b for the negative electrode plate 5 placed inside.

The negative electrode current collector 5b is composed of a metal plate such as, for example, aluminum foil, and the negative electrode active material layer 5a is formed in such a way that a negative electrode mix containing a negative electrode active material composed of, for example, activated carbon, a binder, and a conducting aid is applied onto one or both surfaces of the negative electrode current collector 5b, and dried.

In addition, known binders which are used in negative electrode mixes for lithium ion batteries can be typically used as the binder contained in the negative electrode mix mentioned above, and known additives such as conducting aids can be added to the negative electrode mix.

The positive electrode active material layer 4a can be also formed in such a way that the positive electrode mix containing the positive electrode active material, the binder, and the conducting aid is applied onto the positive electrode current collector 4b by a comma coater, die coater, or gravure printing method, or the like. In addition, the negative electrode active material layer 5a can be also formed in such a way that the negative electrode mix containing the negative electrode active material, the binder, and the conducting aid is applied onto the negative electrode current collector 5b by a comma coater, die coater, or gravure printing method, or the like. However, the positive electrode active material layer 4a and the negative electrode active material layer 5a are preferably formed by coating with the use of a screen printing method. This is because screen printing applies low tension to the current collectors, thus making it possible to use thinner positive electrode current collectors 4b or negative electrode current collectors 5b.

<Electrolytic Solution>

An electrolytic solution with 1.0 mol/L of triethylmethylammoniumtetrafluoroborate dissolved in propylene carbonate can be used as the electrolytic solution.

In addition, an ionic liquid such as 1-ethyl-3-methylimidazoliumtetrafluoroborate and 1-ethyl-3-methylimidazoliumbis(trifluoromethanesulfonyl)imide can be used as the electrolytic solution in the electrical double layer capacitor, and in this case, an ionic liquid containing substantially no organic solvent can be merely used as the electrolytic solution. When the ionic liquid containing substantially no organic solvent is used, a storage device such as an electrical double layer capacitor can be supplied which has high heat resistance, because the ionic liquid has a low vapor pressure even at high temperatures. In addition, in 1-ethyl-3-methylimidazoliumtetrafluoroborate, the tetrafluoroborate as anion is smaller in ionic radius and higher in conductivity, as compared with 1-ethyl-3-methylimidazoliumbis (trifluoromethanesulfonyl)imide, and 1-ethyl-3-methylimidazoliumtetrafluoroborate thus can supply a lower-resistance electrical double layer capacitor.

The electrical double layer capacitor configured as described above according to Embodiment 3 uses the ceramic separator 1 which ensures the porosity and air permeability required for the electrical double layer capacitor, and reduces the strength and shrinkage during heating, thus making it possible to achieve a longer life and increase the reliability.

In addition, the ceramic separator of the composite material composed of the inorganic filler and the organic constituent according to Embodiment 1 can have a pore diameter distribution width reduced as compared with separators composed of polyethylene microporous membranes for storage devices. Therefore, as compared with an electrical double layer capacitor using a separator composed of a polyethylene microporous membrane, the electrical double layer capacitor according to Embodiment 3 can make the distribution of the electrolytic solution uniform in the separator, thus making it possible to achieve a high capacity.

While the lithium ion secondary battery and electrical double layer capacitor configured with the use of the ceramic separator according to Embodiment 1 of the present invention have been described above in Embodiments 2 and 3, the present invention is not to be considered limited to the battery and the capacitor, and can be applied to other storage devices configured to include a separator, such as, for example, a nickel-metal-hydride battery.

### EXAMPLES

### Example 1

In Example 1, the inorganic particulates of spherical silica powder, spherical alumina powder, and spherical titanium oxide powder shown in Table 1 were used as the inorganic filler to prepare eight types of ceramic separators of samples 1 to 8 on the basis of the compositions shown in Table 2. The particle diameters and n values for each inorganic filler are as shown in Table 1, where the silica, alumina, and titanium oxide are respectively 2.20 g-cm⁻³, 3.98 g-cm⁻³, and 4.00 g-cm⁻³ in density. It is to be noted that the particle diameters and n values of the inorganic fillers were measured by a laser-diffraction particle size distribution measurement method.

TABLE 1

| | | | | | | Titanium | | |
|---|---|---|---|---|---|---|---|---|
| | Silica 1 | Silica 2 | Silica 3 | Silica 4 | Alumina | Oxide | Silica 5 | Silica 6 |
| Average | 0.7 | 1.1 | 3.4 | 5.0 | 1.1 | 3.0 | 2.4 | 6.5 |
| Particle | | | | | | | | |
| Diameter | | | | | | | | |
| (μm) | | | | | | | | |
| n value (−) | 1.25 | 1.48 | 1.61 | 1.20 | 1.21 | 1.49 | 0.87 | 1.24 |
| Remarks | Outside | | | | | | Outside | Outside |
| | the | | | | | | the | the |
| | scope | | | | | | scope | scope |

TABLE 2

| Sample | 1 | 2 | 3 | 4 | 5 | 6 | 7 | 8 |
|---|---|---|---|---|---|---|---|---|
| Silica | 100 | 100 | 100 | 100 | — | — | 100 | 100 |
| (parts by | | | | | | | | |
| weight) | | | | | | | | |
| Alumina | | | | | 180.9 | | | |
| (parts by | | | | | | | | |
| weight) | | | | | | | | |
| Titanium | | | | | | 181.8 | | |
| Oxide (parts | | | | | | | | |
| by weight) | | | | | | | | |
| MEK (parts | 80 | 80 | 80 | 80 | 80 | 80 | 80 | 80 |
| by weight) | | | | | | | | |
| Phenol Resin | 2 | 2 | 2 | 2 | 2 | 2 | 2 | 2 |
| (parts by | | | | | | | | |
| weight) | | | | | | | | |
| MEK (parts | 24.6 | 24.6 | 24.6 | 24.6 | 24.6 | 24.6 | 24.6 | 24.6 |
| by weight) | | | | | | | | |
| Phenoxy | 15.7 | 15.7 | 15.7 | 15.7 | 15.7 | 15.7 | 15.7 | 15.7 |
| Resin (parts | | | | | | | | |
| by weight) | | | | | | | | |
| PVC (%) | 75% | 75% | 75% | 75% | 75% | 75% | 75% | 75% |
| Remarks | Silica 1 | Silica 2 | Silica 3 | Silica 4 | Alumina | Titanium | Silica 5 | Silica 6 |
| | outside | | | | | Oxide | outside | outside |
| | the | | | | | | the | the |
| | scope | | | | | | scope | scope |

The types of the inorganic fillers used for each sample are shown in the remarks column of Table 2. For the preparation of slurry, a phenoxy resin having an epoxy group and a phenol resin as a dispersant were used as the organic constituents. This phenol resin acts as a dispersant, and at the same time, also acts as a curing agent for the phenoxy resin. It is to be noted that the density of the organic constituent was adjusted to 1.17 g-cm⁻³.

The dispersant herein was used for the wettability acceleration and dispersion stabilization of the inorganic filler in the slurry.

The slurry was prepared by putting the inorganic filler, the phenol resin, and a methylethylketone (MEK) as a solvent in a 500 mL pot, putting therein grinding media made of partially stabilized zirconia (PSZ) of 5 mm in diameter, carrying out mixing for dispersion for 4 hours with the use of a tumbling ball mill, then putting the phenoxy resin, and carrying out mixing for 2 hours with the use of a tumbling ball mill.

The thus adjusted slurry was applied by a doctor blade method onto a silicone-coated PET film, and then dried to remove the MEK, thereby providing sheet-like ceramic separators of 25 μm in thickness.

The following items were evaluated for the obtained ceramic separators of samples 1 to 8.

(1) Porosity

The porosity was calculated by the following formula, from the actual measurement value of the density calculated by measuring the thickness and weight of a cut sample in a predetermined size and dividing the weight by the volume, and the theoretical density calculated from the composition of the ceramic separator.

(Porosity)={1−(Actual Measurement Value of Density)/(Theoretical Density)}×100

(2) Air Permeability

The Gurley value (the number of seconds required for 100 cc of air to permeate the membrane at a pressure of 0.879 g-m⁻²) was evaluated by a method in conformity with JISP8177 standards.

The larger Gurley value indicates that the permeability is lower.

(3) Strength, Extension Percentage

A test piece of 5 mm in width was cut out from the sheet-like ceramic separator, and set in a tensile tester with a chuck gap of 13 mm. Then, a tensile test was carried out at a testing speed of 7.8 mm-min⁻¹. The maximum stress in the test, which divided by the cross-sectional area of the test piece, was defined as the strength, and the deformation amount until fracture, which was divided by the chuck gap, was defined as the extension percentage.

(4) Shrinkage Rate during Heating

A test piece of 4 cm×4 cm was cut out from the sheet-like ceramic separator, and left in a constant-temperature bath at 150° C. for 30 minutes, and the shrinkage rate of the composite material sheet was measured from the rate of decrease in size between before and after the heating.

Table 3 shows the porosity, air permeability, strength, extension percentage, and shrinkage rate during heating for samples 1 to 8. Table 3 shows the results for a microporous membrane (20 μm in thickness) made of polyethylene together as a comparative example.

TABLE 3

| | | | | | | | Shrinkage | |
|---|---|---|---|---|---|---|---|---|
| | Average | | | | | | Rate | |
| | Particle | n | | Air | | Extension | during | |
| | Diameter | value | Porosity | Permeability | Strength | Percentage | Heating | |
| Sample | (μm) | (−) | (%) | (sec-100 cc⁻¹) | (MPa) | (%) | (%) | Remarks |
| 1 | 0.7 | 1.25 | 18.8 | 1968 | 16 | 72.5 | 4.0 | outside |
| | | | | | | | | the scope |
| 2 | 1.1 | 1.48 | 25.9 | 40 | 15 | 65.2 | 0.5 | |
| 8 | 3.4 | 1.61 | 31.1 | 3 | 18 | 60.3 | 0.5 | |
| 4 | 5.0 | 1.20 | 34.0 | 2 | 14 | 45.0 | 0.0 | |
| 5 | 1.1 | 1.21 | 28.9 | 6 | 19 | 73.4 | 0.0 | |
| 6 | 3.0 | 1.49 | 39.9 | 2 | 12 | 39.2 | 0.5 | |
| 7 | 2.4 | 0.87 | 21.3 | 773 | 19 | 73.4 | 0.5 | outside |
| | | | | | | | | the scope |
| 8 | 6.5 | 1.24 | 36.9 | 2 | 6 | 5.0 | 1.0 | outside |
| | | | | | | | | the scope |
| Comparative | — | — | 42.1 | 111 | 31 | 225 | 34.0 | Polyethylene |
| Example | | | | | | | | Microporous |
| | | | | | | | | Membrane |

As shown in Table 3, the ceramic separator of sample 1 using silica 1 of 0.7 μm less than 1 μm in average particle diameter as the inorganic filler has an extremely low air permeability and a high shrinkage rate during heating, as compared with samples 2 to 6 within the scope of the present invention, and it is determined that sample 1 is not suitable as a ceramic separator for a storage device.

In addition, the air permeability is extremely low in the case of sample 7 which has an average particle size of 2.4 μm more than 1 μm while the inorganic filler has an n value of 0.87 outside the scope of the present invention. In contrast, the air permeability is sufficiently high in the case of sample 4 with an n value of 1.2 within the scope of the present invention. This is considered because sample 7 is filled densely with the inorganic filler by smaller particles inserted in the gaps between larger particles due to the fact that the n value of the inorganic filler used in sample 7 is large in particle size distribution width as compared with samples 2 to 6 within the scope of the present invention, resulting in the low porosity and the low air permeability.

From these results, it is determined that the porosity and the air permeability can be increased by the use of an inorganic filler with an average particle diameter of 1 μm or more and an n value of 1.2 or more for the ceramic separator.

In addition, in the case of sample 8 with an average particle size of 6.5 μm greater than 5 μm, the porosity and the air permeability are comparable even as compared with samples 2 to 6 within the scope of the present invention, while the film strength is weak as compared with samples 2 to 6 within the scope of the present invention. In contrast, the strength is sufficient in the case of sample 4 with an average particle diameter of 5.0 μm as the upper limit within the scope of the present invention.

Therefore, it is determined that it is preferable to adjust the average particle diameter of the inorganic filler to 5 μm or less.

Furthermore, samples 5 and 6 using, as the inorganic filler, the alumina and titanium oxide with average particle diameters and n values within the scope of the present invention are, as shown in Table. 3, also comparable as compared with samples 2 to 4 using the silica within the scope of the present invention, and it has been confirmed that the separator is not to be considered limited by the material of the inorganic filler as long as the average particle diameter and the n value fall within the scope of the present invention.

In addition, samples 1 to 8 with a pigment volume concentration of 75% according to the present example have no substantial difference found in shrinkage rate during heating, while it has been confirmed that the microporous membrane of polyethylene according to the comparative example undergoes a significant shrinkage by the heating at 150° C.

It has been confirmed that the ceramic separator according to the present invention solves the problem of shrinkage by heating, which is a problem of the microporous membrane of polyethylene.

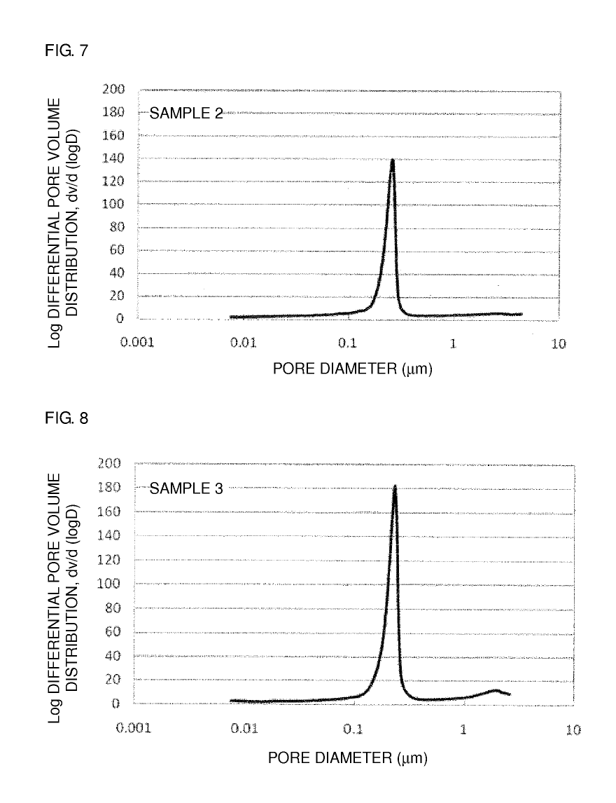

Furthermore, in Example 1, the pore diameter distribution of the sheet was measured by a mercury intrusion technique for samples 1, 2, and 3, and the comparative example. The relationship between the pore diameter and the Log differential pore volume distribution (dV/d(logD)) is shown in FIGS. 6 through 9.

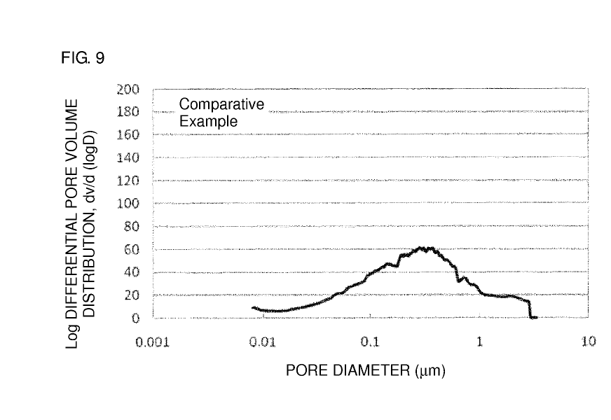

As shown in FIG. 9, it is determined that the pore diameter distribution is broad in the sheet according to the comparative example, while the pore diameter distribution is narrow in samples 1, 2, and 3 as the ceramic separators composed of the inorganic filler and the organic constituent. In addition, it is determined that samples 2 and 3 within the scope of the present invention have larger pore volumes as compared with sample 1. Thus, it is determined that the pore volume can be increased by setting the particle size distribution and n value within the scope of the present invention.

### Example 2

In Example 2, lithium ion secondary batteries were prepared and evaluated with the use of the ceramic separators of samples 1 to 8 according to Example 1 and the separator according to the comparative example.

(Preparation of Positive Electrode)

With the use of a lithium-manganese composite oxide (LMO) represented by LiMn₂O₄ as a positive electrode active material, this positive electrode active material, a carbon material as a conducting aid, and a N-methyl-2-pyrrolidone (NMP) solution of polyvinylidene fluoride (PVDF) dissolved as a binder were prepared so that the ratio by weight was 88:6:6 among the positive electrode active material, the conducting aid, and the binder. This prepared product was subjected to kneading to prepare positive electrode mix slurry. This positive electrode mix slurry was applied onto a positive electrode current collector of aluminum foil, dried, and extended by applying a pressure with a roller, and a current collecting tab was attached thereto to prepare a positive electrode.

In this case, the amount of the positive electrode mix applied per unit area was adjusted to 14.0 mg/cm², and the filling density was adjusted to 2.7 g/mL. The unit capacity of the positive electrode was measured in the range of 3.0 to 4.3 V with the use of 1 mol-l¹ of LiPF₆ as an electrolyte for an electrolytic solution, and a mixed solvent of ethylene carbonate (EC) and diethyl carbonate (DEC) mixed at a volume ratio of 3:7 as a solvent, and with the use of a lithium metal for the counter electrode. As a result, the unit capacity of 110 mAh was obtained per gram.

(Preparation of Negative Electrode)

A spinel-type lithium-titanium composite oxide represented by Li₄Ti₅O₁₂ as a negative electrode active material, carbon as a conducting aid, and an N-methylpyrrolidon (NMP) solution of polyvinylidene fluoride (PVDF) as a binder were prepared so that the ratio by weight was 93:3:4 among the negative electrode active material, the conducting aid, and the binder. This prepared product was subjected to kneading to prepare negative electrode mix slurry. This negative electrode mix slurry was applied onto a negative electrode current collector of aluminum foil, dried, and extended by applying a pressure with a roller, and a current collecting tab was attached thereto to prepare a negative electrode.

In this case, the amount of the negative electrode mix applied per unit area was adjusted to 13.5 mg/cm², and the filling density was adjusted to 2.1 g/mL. The unit capacity of the negative electrode was measured in the range of 1.0 to 2.0 V with the use of 1 mol-l⁻¹ of LiPF₆ as an electrolyte for an electrolytic solution, and a mixed solvent of ethylene carbonate (EC) and diethyl carbonate (DEC) mixed at a volume ratio of 3:7 as a solvent, and with the use of a lithium metal for the counter electrode. As a result, the unit capacity of 165 mAh was obtained per gram.

(Preparation of Non-Aqueous Electrolytic Solution)

With the use of a mixed solvent of cyclic carbonates: ethylene carbonate (EC) and diethyl carbonate (DEC) mixed at a volume ratio of 3:7 as a non-aqueous solvent, LiPF₆ as an electrolyte was dissolved in this mixed solvent so as to reach a concentration of 1 mol/L, thereby preparing a non-aqueous electrolytic solution.

(Preparation of Battery)

For each of the ceramic separators of samples 1 to 8 according to Example 1 and the separator composed of the microporous membrane of polyethylene as the comparative example, the separator interposed between the positive electrode and negative electrode prepared was housed in an exterior member composed of a laminate film including aluminum as an interlayer.

Then, after injecting the prepared non-aqueous electrolytic solution in the exterior member, the opening of the exterior member was sealed for carrying out an initial charge-discharge cycle. In this initial charge-discharge cycle, at 25° C., each battery was charged until the voltage reached 2.75 V with a charging current of 4.8 mA (=0.4 C), and then, while the charging current was attenuated with the voltage kept at 2.75, each battery was charged until the charging current reached 1/50 C. After leaving for 10 minutes, constant current discharge was conducted with a discharging current of 4.8 mA and a cutoff voltage of 1.25 V. After carrying out three cycles of charge and discharge with a charging-discharging current value set at 12 mA (=1 C), one cycle of charge and discharge was carried out under the same condition as in the initial charge-discharge cycle, and the discharge capacity in this case was calculated with 1 C.

In Example 2, the following items were evaluated as battery characteristics.

(1) Measurement of Input/Output Initial Direct-Current Resistance (DCR) at 25° C. in 60% State of Charge (SOC)

The 1 C capacity obtained with a charging current of 4.8 mA at 25° C. was regarded as 100%, and each battery was charged with 60% of the capacity. With a charging current of 12 mA (=1 C) and an upper limit voltage of 2.75 V, each battery was charged for 10 seconds, and left for 10 minutes. Then, with a discharging current of 12 mA and a lower limit voltage of 1.25 V, each battery was discharged for 10 seconds, and left for 10 minutes. Subsequently, the charge and discharge were carried out for 10 seconds while varying the charging-discharging current value to 24 mA (=2 C), 72 mA (=6 C), and 120 mA (=10 C). From the thus obtained voltage value after 10 seconds with respect to each charging current value, the input DCR was calculated for each battery. Likewise, from the voltage value after 10 seconds with respect to each discharging current value, the output DCR was calculated for each battery.

(2) Reliability Test

The battery was left in a constant-temperature bath at 150° C. to measure the time that elapsed before loosing the function of the battery, and evaluate the reliability and safety at the high temperature.

Table 4 shows the input/output DCR at 25° C. in SOC 60% and the result of the reliability test for the batteries using the respective porous membranes for the separators. The input/output DCR is high in the case of the batteries using samples 1 and 7 with lower degrees of porosity and air permeability for the ceramic separators. On the other hand, the batteries using samples 2, 3, 4, 5, 6, and 8 with higher degrees of porosity and air permeability for the ceramic separators exhibited input/output DCRs equivalent to that of the battery using the porous membrane of polyethylene as the comparative example for the separator.

TABLE 4

| | Input | Output | Time to | |
|---|---|---|---|---|
| Porous | DCR at | DCR at | short circuit | |
| Membrane | 25° C. (Ω) | 25° C. (Ω) | (min) | Remarks |
| 1 | 2.71 | 3.25 | >60 | outside the scope |
| 2 | 1.51 | 1.52 | >60 | |
| 8 | 1.19 | 1.22 | >60 | |
| 4 | 1.08 | 1.26 | >60 | |
| 5 | 1.14 | 1.19 | >60 | |
| 6 | 1.25 | 1.32 | >60 | |
| 7 | 2.60 | 2.85 | >60 | outside the scope |
| 8 | 0.88 | 0.91 | 45 | outside the scope |
| Comparative | 1.10 | 1.13 | 18 | Polyethylene |
| Example | | | | Microporous |
| | | | | Membrane |

In the reliability test in the case of leaving at 150° C., short circuit was confirmed in a short period of time in the case of the battery using the porous membrane of polyethylene as the comparative example for the separator. On the other hand, in the case of the batteries using the ceramic separators of samples 1 to 8, the time to short circuit is longer as compared with the comparative example, and it is determined that the batteries are excellent in reliability. However, it has been confirmed that in the case of sample 8 with the inorganic filler larger in average particle diameter, the time to short circuit is somewhat shorter, and inferior in reliability as compared with the other samples.

From Examples 1 and 2 above, it has been confirmed that in the case of the pigment volume concentration of 75%, when the average particle diameter of the inorganic filler is set in the range of 1 to 5 μm, and when the particle size distribution width is reduced in such a way that the particle size distribution of the inorganic filler has a slope of 1.2 or more in the case of the approximation by a Rosin-Rammler distribution, the porosity and air permeability required as the ceramic separator for a storage device can be ensured, and the strength of the ceramic separator can be increased.

In addition, it has been confirmed the ceramic separator for a storage device, which has the composite material composed of the inorganic filler and the organic constituent, can have a pore diameter distribution width reduced as compared with separators composed of polyethylene microporous membranes for storage devices.

Furthermore, it has been confirmed that the lithium ion secondary battery configured with the use of the ceramic separator according to Example 1 has input/output DCR characteristics equivalent to those of the battery using the conventional polyethylene microporous membrane for the separator, and has excellent battery reliability at high temperatures as compared with the battery using the conventional polyethylene microporous membrane for the separator.

This is because the ceramic separator according to Example 1 undergoes almost no shrinkage even under high temperature.

### Example 3

In Example 3, ceramic separators of samples 9 to 12 with a pigment volume concentration varied in the range of 50% to 85% with the use of silica 3 shown as the inorganic filler in Table 1, and ceramic separators of samples 13 to 14 using silica 2 and silica 4 shown in Table 1 were prepared, and evaluated in the same way as in Example 1.

Table 5 shows details on the compositions of the slurry according to Example 3. It is to be noted that the methods for preparing and evaluating the slurry and the ceramic separators in Example 3 are the same as in Example 1.

TABLE 5

| Sample | 9 | 10 | 3 | 11 | 12 | 13 | 14 |
|---|---|---|---|---|---|---|---|
| Silica (parts | 100 | 100 | 100 | 100 | 100 | 100 | 100 |
| by weight) | | | | | | | |
| MEK (parts by | 80 | 80 | 80 | 80 | 80 | 80 | 80 |
| weight) | | | | | | | |
| Phenol Resin | 2 | 2 | 2 | 2 | 2 | 2 | 2 |
| (parts by | | | | | | | |
| weight) | | | | | | | |
| MEK (parts by | 76.4 | 62.0 | 24.6 | 16.8 | 11.0 | 62.0 | 16.8 |
| weight) | | | | | | | |
| Phenoxy Resin | 50.9 | 41.3 | 15.7 | 11.2 | 7.3 | 20.7 | 11.2 |
| (parts by | | | | | | | |
| weight) | | | | | | | |
| PVC (%) | 50 | 55 | 75 | 80 | 85 | 55 | 80 |
| Remarks | Silica 3 | Silica 3 | Silica 3 | Silica 3 | Silica 3 | Silica 2 | Silica 4 |
| | outside | | | | outside | | |
| | the scope | | | | the scope | | |

Table 6 shows the porosity, air permeability, strength, extension percentage, and shrinkage rate during heating for samples 9 to 14 according to Example 3.

TABLE 6

| | | Average | | | | | | |
|---|---|---|---|---|---|---|---|---|
| | | Particle | | Air | | Extension | Shrinkage | |
| | PVC | Diameter | Porosity | Permeability | Strength | Percentage | Rate during | |
| Sample | (%) | (μm) | (%) | (sec/100 cc) | (MPa) | (%) | Heating (%) | Remarks |
| 9 | 50 | 3.4 | 12.3 | 2484 | 45 | 99.2 | 6.5 | outside the |
| | | | | | | | | scope |
| 10 | 55 | 3.4 | 29.0 | 14 | 42 | 87.4 | 0.5 | |
| 3 | 75 | 3.4 | 31.1 | 3 | 18 | 60.3 | 0.5 | |
| 11 | 80 | 3.4 | 40.3 | 2 | 16 | 26.7 | 0.0 | |
| 12 | 85 | 3.4 | 46.4 | 1 | 7 | 3.0 | 0.0 | outside the |
| | | | | | | | | scope |
| 13 | 55 | 1.1 | 30.5 | 25 | 39 | 77.1 | 0.5 | |
| 14 | 80 | 5.0 | 43.4 | 1 | 14 | 24.3 | 0.5 | |

As indicated by samples 9 to 12 in Table 6, when the same silica powder (silica 3) was used, with the increase in pigment volume concentration, the porosity and air permeability were increased, while the strength and the extension percentage were decreased. In the case of sample 9 with a PVC less than 55%, the porosity and the air permeability are too low. It is shown that the pigment volume concentration less than 55% increases the volume of the organic constituent present between the inorganic fillers, thereby drastically reducing the porosity and the air permeability.

In addition, because sample 12 with a pigment volume concentration greater than 80% is excessively low in strength and extension percentage, it has been confirmed that these composite material sheets are not suitable as ceramic separates for storage devices, due to the shortage in the amount of the organic constituent for maintaining the strength and extension percentage for the composite material sheets.

In addition, sample 11 with a pigment volume concentration of 80% has an extension percentage of 26.7%, while sample 11 with a pigment volume concentration of 85% has an extension percentage of 3.0%, and it is thus shown that the pigment volume concentration greater than 80% drastically decreases the strength and extension percentage of the ceramic separator as the composite material.

In the case of sample 9 with a pigment volume concentration of 50%, the volume of the organic constituent is larger which is present in the gap filled with the inorganic filler, and the shrinkage rate during heating is thus higher. In addition, the shrinkage rate during heating is 0.5% in the case of sample 10 with a pigment volume concentration of 55%, whereas shrinkage rate during heating is 6.5% in the case of sample 9 with a pigment volume concentration of 50%, which indicates that the shrinkage rate during heating is increased drastically when the pigment volume concentration is less than 55%.

In addition, the porosity, air permeability, strength, and extension percentage in the ceramic separator are considered to be influenced by the combination of the average particle size and n value of the inorganic filler with the PVC of the ceramic separator as the composite member. Thus, in order to examine this effect, in Example 3, ceramic separators of samples 13 to 14 were prepared with the use of silica 2 and silica 4 differing from silica 3 in average particle diameter and n value, and evaluated in the same way as in Example 1. Sample 13 was prepared with the assumption that the combination of silica 2 of 1.1 μm in average particle diameter with a pigment volume concentration of 55% would result in the lowest porosity and air permeability within the scope of the present invention, whereas sample 14 was prepared with the assumption that the combination of the average particle diameter of 5.0 μm with a PVC of 80% would result in the lowest strength and extension percentage within the scope of the present invention.

As a result, it can be confirmed that samples 13 and 14 each have the porosity, air permeability, strength, and extension percentage which can be adapted to storage devices such as, for example, lithium ion secondary batteries.

### Example 4

In Example 4, lithium ion secondary batteries were prepared with the use of the ceramic separators of samples 9 to 14, and the characteristics of the batteries were evaluated. The method for preparing lithium ion secondary batteries and the methods for evaluating the characteristics are the same as in Example 2.

Table 7 shows the input/output DCR at 25° C. in SOC 60% and the result of the reliability test for the prepared lithium ion secondary batteries.

TABLE 7

| Porous | Input DCR at | Output DCR | Time to short | |
|---|---|---|---|---|
| Membrane | 25° C. (Ω) | at 25° C. (Ω) | circuit (min) | Remarks |
| 9 | 3.33 | 3.81 | >60 | outside the scope |
| 10 | 1.89 | 1.94 | >60 | |
| 3 | 1.19 | 1.22 | >60 | |
| 11 | 0.89 | 0.89 | >60 | |
| 12 | 0.91 | 0.93 | 37 | outside the scope |
| 13 | 1.95 | 2.02 | >60 | |
| 14 | 1.23 | 1.28 | >60 | |

As shown in Table 7, the lithium ion secondary batteries using the ceramic separators of samples 3, 10, 11, 12, 13, and 14 exhibited the input/output DCR equivalent to that of the lithium ion secondary battery using the porous membrane of polyethylene according to the comparative example for the separator.

In contrast, the input/output DCR is higher in the case of the lithium ion secondary battery using the ceramic separator of sample 9 with the low pigment volume concentration of 50% outside the scope of the present invention. This is considered because sample 9 is lower in porosity and air permeability.

In addition, as shown in Table 7, in the case of lithium ion secondary batteries using the ceramic separators of samples 3, 9, 10, 11, 13, and 14, the time to short circuit is longer as compared with the comparative example, and it has been thus confirmed that the batteries are excellent in reliability. However, in the case of the lithium ion secondary battery using the ceramic separator of sample 12 with a high pigment volume concentration of 85%, the time to short circuit is longer as compared with the comparative example, while the time to short circuit is somewhat shorter as compared with the other samples, and it is thus determined that the lithium ion secondary battery using the ceramic separator of sample 12 is inferior in reliability as compared with the lithium ion secondary batteries using the ceramic separators within the scope of the present invention.

From the above results in Examples 3 and 4, it is determined that when the inorganic filler is used which has an average particle diameter of 1 μm or more and 5 μm or less, and has an n value of 1.2 or more, a ceramic separator with excellent porosity, air permeability, strength, extension percentage, and shrinkage rate during heating, which can be adapted to storage devices, can be prepared in the ratio of 55% to 80% in terms of pigment volume concentration.

Furthermore, it has been confirmed that the battery using the ceramic separator as the composite material in the range of 55% to 80% in terms of pigment volume concentration has input/output DCR characteristics equivalent to those of the battery using the conventional polyethylene microporous membrane for the separator, and has excellent battery reliability at high temperatures as compared with the battery using the conventional polyethylene microporous membrane for the separator.

### DESCRIPTION OF REFERENCE SYMBOLS

1 ceramic separator
2, 4 positive electrode plate
2a, 4a positive electrode active material
2b, 4b positive electrode current collector
3, 5 negative electrode plate
3a, 5a negative electrode active material layer
3b, 5b negative electrode current collector
10 battery element
20 capacitor element

1. A ceramic separator comprising:
an inorganic filler; and
an organic constituent,
wherein the inorganic filler in a range of 55 to 80% on the basis of a pigment volume concentration, and
the inorganic filler has an average particle diameter of 1 μm to 5 μm, and a grain size distribution with a slope of 1.2 or more based on an approximation by a Rosin-Rammler distribution.

2. The ceramic separator according to claim 1, wherein the ceramic separator contains the inorganic filler in the range of 60 to 80% on the basis of the pigment volume concentration, and
the inorganic filler has an average particle diameter of 3 μm to 5 μm.

3. The ceramic separator according to claim 1, wherein the ceramic separator contains the inorganic filler in the range of 60 to 75% on the basis of the pigment volume concentration.

4. The ceramic separator according to claim 1, wherein the organic constituent has a heatproof temperature of 150° C. or higher.

5. The ceramic separator according to claim 1, wherein the inorganic filler is selected from the group consisting of oxides and nitrides.

6. The ceramic separator according to claim 5, wherein the inorganic filler is selected from the group consisting of oxides of silica, alumina, titania, magnesia, and barium titanate.

7. The ceramic separator according to claim 5, wherein the inorganic filler is selected from the group consisting of silicon nitride and aluminum nitride.

8. A storage device comprising:
a positive electrode plate;
a negative electrode plate; and
the ceramic separator according to claim 1 between the positive electrode plate and the negative electrode plate.

9. The storage device according to claim 8, wherein the ceramic separator contains the inorganic filler in the range of 60 to 80% on the basis of the pigment volume concentration, and
the inorganic filler has an average particle diameter of 3 μm to 5 μm.

10. The storage device according to claim 8, wherein the ceramic separator contains the inorganic filler in the range of 60 to 75% on the basis of the pigment volume concentration.

11. The storage device according to claim 8, wherein the organic constituent has a heatproof temperature of 150° C. or higher.

12. The storage device according to claim 8, wherein the inorganic filler is selected from the group consisting of oxides and nitrides.

13. The storage device according to claim 12, wherein the inorganic filler is selected from the group consisting of oxides of silica, alumina, titania, magnesia, and barium titanate.

14. The storage device according to claim 12, wherein the inorganic filler is selected from the group consisting of silicon nitride and aluminum nitride.

15. The storage device according to claim 8, wherein the storage device is a lithium ion secondary battery

16. The storage device according to claim 8, wherein the positive electrode plate comprises a positive electrode current collector and a positive electrode active material layer on at least one surface of the positive electrode current collector.

17. The storage device according to claim 16, wherein the negative electrode plate comprises a negative electrode current collector and a negative electrode active material layer on at least one surface of the negative electrode current collector.

18. The storage device according to claim 8, wherein the negative electrode plate comprises a negative electrode current collector and a negative electrode active material layer on at least one surface of the negative electrode current collector.

19. The storage device according to claim 8, wherein the storage device is an electrical double layer capacitor.

20. The storage device according to claim 19, wherein at least one of the positive electrode plate and the negative electrode plate comprises an electrode current collector and an electrode active material layer on at least one surface of the electrode current collector.
